(19) United States
(12) Patent Application Publication
(10) Pub. No.: US 2015/0363195 A1
(43) Pub. Date: Dec. 17, 2015

(54) SOFTWARE PACKAGE MANAGEMENT

(71) Applicant: npm, Inc., Oakland, CA (US)

(72) Inventor: Isaac Z. Schlueter, Oakland, CA (US)

(21) Appl. No.: 14/734,962

(22) Filed: Jun. 9, 2015

Related U.S. Application Data
(60) Provisional application No. 62/012,942, filed on Jun. 16, 2014.

(51) Int. Cl. G06F 9/44; G06F 17/30

(52) U.S. Cl. CPC G06F 8/71; G06F 17/3007

(57) ABSTRACT

Systems and methods for software package management are provided to avoid dependency conflicts that occur when running software packages. According to one embodiment of this disclosure, there is provided a computer-implemented method for organizing a plurality of software modules. The method can include receiving a request for organizing the plurality of software modules, determining a dependency relationship between the plurality of software modules, creating or updating a file system of nested folders based on the dependency relationship between the plurality of software modules, and storing the plurality of software modules in the file system of nested folders, wherein each folder is associated with one of the software modules based on the dependency relationship between the plurality of software modules.

### CROSS-REFERENCE TO RELATED APPLICATION

This application claims the benefit of U.S. Provisional Patent Application Ser. No. 62/012,942 filed on Jun. 16, 2014, entitled “Software Package Management,” which is incorporated herein by reference in its entirety for all purposes.

### TECHNICAL FIELD

The present disclosure generally relates to software package management, and, more particularly, to systems and methods for organizing software package modules.

### BACKGROUND

The approaches described in this section could be pursued, but are not necessarily approaches that have been previously conceived or pursued. Therefore, unless otherwise indicated, it should not be assumed that any of the approaches described in this section qualify as prior art merely by virtue of their inclusion in this section.

At present, many software products are developed in the form of software packages. Generally speaking, a software package can include multiple software pieces, each of which encapsulates one or more related functions, and these pieces can act together to provide certain functionalities. Software pieces may include, for example, software modules (e.g., software libraries and independent software applications) or software components (e.g., a web service or a web resource).

Typically, software packages are developed with one of the available package management systems (PMS). A software package can be provided as compiled code with additional metadata, such as a package description, version, and dependencies of corresponding software pieces. At present, many software packages are built around a PMS such that every piece of software is available in online repositories and users can conveniently install, update, downgrade, or uninstall them. For example, software libraries can be packaged and made available in online repositories for common use by software pieces of multiple software packages.

While building software packages, developers often rely on software modules developed by a community of developers and available in online repositories. Some communities of developers can provide software packages including many thousands of libraries and modules. These software modules are often under permanent development since they require revisions from time to time, for example, to fix bugs or to add/remove certain functions. Multiple versions of software modules can lead to a situation in which different parts of a software package depend on different versions of the same software module. Such dependency conflicts may require developers of software packages to understand the subtleties of each software module, which can be a dependency that they are unfamiliar with. Therefore, a desirable PMS may need to organize dependencies to avoid a situation in which dependencies-of-dependencies may be in conflict or where developers need to repeatedly update versions of software modules.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Embodiments of the present disclosure relate generally to a software package manager, which allows analyzing dependencies of software modules in a software package, including determining cyclic or conflicting dependencies. The dependency information can be used to create or update a file system of nested folders, where each local folder can be associated with a first software module and include sub-folders for storing second software modules on which the first software module depends. In some embodiments, the software package management is operable to look up a required software module in a local folder. If a required software module is not found in the local folder, the software package management can be configured to look up the required module in a parent nested folder, and so forth.

According to one aspect of this disclosure, there is provided a computer-implemented method for organizing a plurality of software modules. The method can comprise the steps of receiving a request for organizing the plurality of software modules, determining a dependency relationship between the plurality of software modules, creating or updating a file system of nested folders based on the dependency relationship between the plurality of software modules, and storing the plurality of software modules in the file system of nested folders, wherein each folder is associated with one of the software modules based on the dependency relationship between the plurality of software modules.

In certain embodiments, one or more of the software modules include a software library. Any and all of the software modules can be associated with and required to operate as a single software application.

In certain embodiments, the file system of nested folders includes a plurality of first level folders, wherein each of the first level folders is associated with first software modules. At least one of the first software modules stored in the first level folders can depend on one or more second software modules, wherein the second software modules differ from the first software modules. The second software modules, on which the at least one of the first software modules depends, can be stored in the one or more second level folders, wherein the one or more second level folders are sub-folders of the one or more first level folders associated with the at least one of the first software modules.

In certain embodiments, the step of storing the plurality of software modules in the file system of nested folders includes placing the software modules in the folders in such a way that there are no cyclic dependency or conflicting dependency between two or more of the software modules during runtime (also variously referred to herein as run-time and run time) of a software package that depends on the two or more software modules.

In certain embodiments, the method further comprises analyzing the dependency relationship between the plurality of software modules by looking up a first software module in a first folder, wherein the first folder is associated with a second software module, with the second software module being dependent on the first software module; and cyclically, responsive to the looking up, if the first software module is not found in the first folder, looking up the first software module in a second folder, wherein the second folder is associated with a third software module and the third software module is dependent on the second software module.

In certain embodiments, the step of determining the dependency relationship between the plurality of software modules includes determining a cyclic dependency or a conflicting dependency between two or more of the software modules.

According to another aspect of this disclosure, there is provided a software package manager. The software package manager may include a computing device including at least one processor and a memory storing processor-executable codes, which, when implemented by the at least one processor, cause the at least one processor to perform the steps of receiving a request for organizing the plurality of software modules, determining a dependency relationship between the plurality of software modules, creating or updating a file system of nested folders based on the dependency relationship between the plurality of software modules, and storing the plurality of software modules in the file system of nested folders, wherein each folder is associated with one of the software modules based on the dependency relationship between the plurality of software modules.

In yet another aspect of the disclosure, there is provided a non-transitory processor-readable medium having instructions stored thereon, which, when executed by one or more processors, cause the one or more processors to implement a method for organizing a plurality of software modules, with the method comprising receiving a request for organizing the plurality of software modules, determining a dependency relationship between the plurality of software modules, creating or updating a file system of nested folders based on the dependency relationship between the plurality of software modules, and storing the plurality of software modules in the file system of nested folders, wherein each folder is associated with one of the software modules based on the dependency relationship between the plurality of software modules.

Additional objects, advantages, and novel features will be set forth in part in the detailed description, which follows, and in part will become apparent to those skilled in the art upon examination of the following detailed description and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example, and not by limitation, in the figures of the accompanying drawings.

FIG. 1 is a block diagram illustrating an example program and package dependency thereof.

FIG. 2 is a block diagram illustrating an example file system for organizing packages of the program shown in FIG. 1.

FIG. 3 is block diagram illustrating an example program with a cyclic package dependency.

FIG. 4 is a block diagram illustrating an example file system for organizing packages of the program shown in FIG. 3.

FIG. 5 is a process flow diagram showing an example method for organizing a plurality of software modules.

FIG. 6 is a process flow diagram showing an example method for analyzing a dependency relationship between a plurality of software modules.

FIG. 7 illustrates an example computing system that can be used to implement embodiments of the disclosed technology.

### DETAILED DESCRIPTION

The following Detailed Description section includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter.

The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Embodiments of the present disclosure may be implemented using a variety of technologies. For example, methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a transitory or non-transitory storage medium such as a disk drive or computer-readable medium. It should be noted that methods disclosed herein can be implemented by a server, network device, general-purpose computer (e.g., a desktop computer, tablet computer, laptop computer), mobile device (e.g., cellular phone, smart phone), and so forth.

The technology of this disclosure relates to systems and methods for software package management. Embodiments of the present technology can allow avoiding dependency conflicts between software modules when running or installing a software package.

As discussed above, the term “software package” can mean a bundle of software pieces, each of which provides one or more related intended functions, and these pieces can act together. Software pieces may include various software modules or components (e.g., a web service or web resource). The term “software module,” as used herein, can mean a group of code representing instructions that can be executed at a computing system or processor to perform some functionality. Examples of software modules include, but are not limited to, software applications, software libraries (e.g., statically-linked libraries or dynamically-linked libraries), and application frameworks.

According to embodiments of this disclosure, software packages can be built based upon software package managers. One example of software package managers is the “npm” package manager utilized in the “Node.js” environment. Specifically, Node.js is an open source, cross-platform runtime environment for server-side and networking applications. Node.js provides an event-driven architecture and an input-output application programming interface (API) that allows throughput and scalability of applications. Node.js can be effectively used by developers as a front-end build tool. Node.js can be used to build network programs such as web services.

The “npm” package manager can be bundled and installed automatically with the “Node.js” environment. In embodiments of this disclosure, the “npm” package manager (also referred herein to as “package manager” for simplicity) allows publishing and sharing of Node.js modules (e.g., libraries) by a developer community. The package manager can also allow installing, updating, or uninstalling Node.js modules or other software modules.

The package manager is also configured to manage dependencies between software modules used in software packages such as Node.js. In a simple scenario, the package manager can be used by developers to manually install software modules and manage software module dependencies from the command line. For example, the package manager can allow users to install Node.js modules that individually depend on various other software modules such as software libraries stored in online repositories. Because these software libraries can be routinely updated or replaced with newer versions of the same, it is important that the package manager allows updating the software package with up-to-date software components.

Moreover, developers of software modules may be independent from owners of software packages using their software modules. For this reason, the developers may not know who is using the code of these modules and how it is being used. The owners of software packages may want to have the software package utilize the latest versions of software modules available.

The embodiments of this disclosure provide an approach for maintaining, installing, updating, and uninstalling software modules, such as Node.js modules, where these modules do not create dependency conflicts. Because this approach allows automating of the process, it significantly simplifies the process of designing software products.

A dependency conflict can arise around shared software modules (e.g., libraries) on which several other software modules can depend, but the other software modules depend on different and incompatible versions of the shared modules. If the shared software module can only be installed in a single version, the problem can be resolved by obtaining a newer version of the dependent software module. This, in turn, may break other dependencies and push the problem to another set of software modules, thereby creating what developers can refer to as “dependency hell.”

There may be various dependency conflicts. For example, a cyclic dependency can arise when Software Module X, version 1 depends on Software Module Y, which in turn depends on Software Module X, version 2. A long version of this issue may look as follows. Software Module X, version 1 depends on Software Module A, which depends on Software Module B, which depends on Software Module C, which depends on the original Software Module X, version 2.

In another example, a conflicting dependency can arise when Software Module X depends on Library 1, version 1, and Software Module Y depends on Library 1, version 2, and different versions of the Library 1 cannot be simultaneously installed, then Software Module X and Software Module Y cannot simultaneously be used (or installed).

The embodiments of this disclosure allow automatic elimination of dependency conflicts for a software package that uses multiple software modules that depend on each other. Generally, the embodiments provide systems and methods for organizing software modules, which may include the steps of: (i) determining a dependency relationship between software modules; (ii) creating or updating a file system of nested folders based on the determined dependency relationship; and (iii) storing the software modules in the file system such that each folder is associated with a particular software module based on the determined dependency relationship, thereby avoiding cyclic or conflicting dependencies during run time of a software package. More specifically, if the software package employs a certain number of software modules, the file system is created to include at least the same number of first level folders, and each of the software modules is individually placed in the first level folder. If any of the software modules depend on second software modules, the first level folders of these software modules will include sub-folders (i.e., second level folders) to store copies or metadata of the second software modules, and so forth. This approach can be scaled to any number of folders, sub-folders, and software modules, which gives great flexibility and ease in designing software packages.

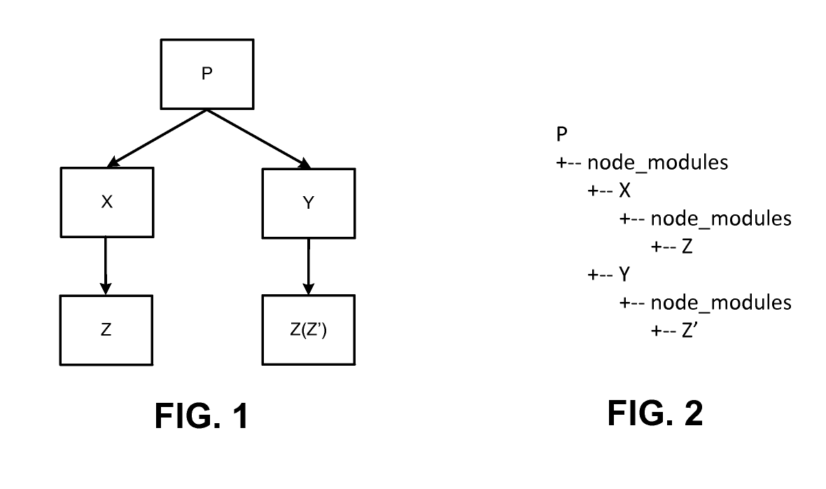

Referring now to the drawings, FIGS. 1-4 further illustrate the principles of the present technology by showing certain implementation examples. Specifically, FIG. 1 is a block diagram illustrating an example software program application P and dependencies thereof. The software program application P may relate to a part or a whole of a software package. The software program application P depends on two software modules, such as, for example, a software library X and a software library Y. The software library X depends on a software library Z and the software library Y depends on a software library Z′. The software library Z′ is a different version of the library Z. In a regular software package manager, the program application P cannot be executed or installed due to the conflict in library dependencies since two version of the library Z cannot co-exist in the same program. The present technology resolves this issue by creating a file system of nested folders for storing software modules such that there are no dependency conflicts between the software modules.

FIG. 2 is a block diagram showing an example file system for organizing software package libraries of the example software program application P shown in FIG. 1. According to the example of FIG. 2, the software libraries X and Y, and other libraries that the software program application P depends on, are placed in the folder P/node_modules. The software library Z and other libraries, which the software library X depends on, is placed in folder P/node_modules/X/node_modules. The version of software library Z′ and other libraries, which the software library Y depends on, is placed in the folder P/node_modules/Y/node_modules. Thus, the software modules of the package are installed in nested sub-folders. If a run-time system is configured to first start looking for dependencies in a local nested folder associated with the package, then according to embodiments of the present technology, the software package manager places the two versions of library Z in two different local folders (P/node_modules/X/node_modules and P/node_modules/Y/node_modules), thus avoiding a run-time library dependency conflict.

By way of example and not limitation, when software program application P executes require(“X”) instruction, it loads the code from file P/node_modules/X. When software program application P executes require(“Y”) instruction, it loads the code from P/node_modules/Y. When a code from the software library X executes require(“Z”) instruction, it loads the Z code from P/node_modules/X/node_modules/Z. When a code from software library Y executes require(“Z”) instruction, it loads the Z code from P/node_modules/Y/node_modules/Z. This allows two copies of the conflicted dependency(two different versions of library Z) to co-exist in the same memory space, since the two references are local and not shared at a global level.

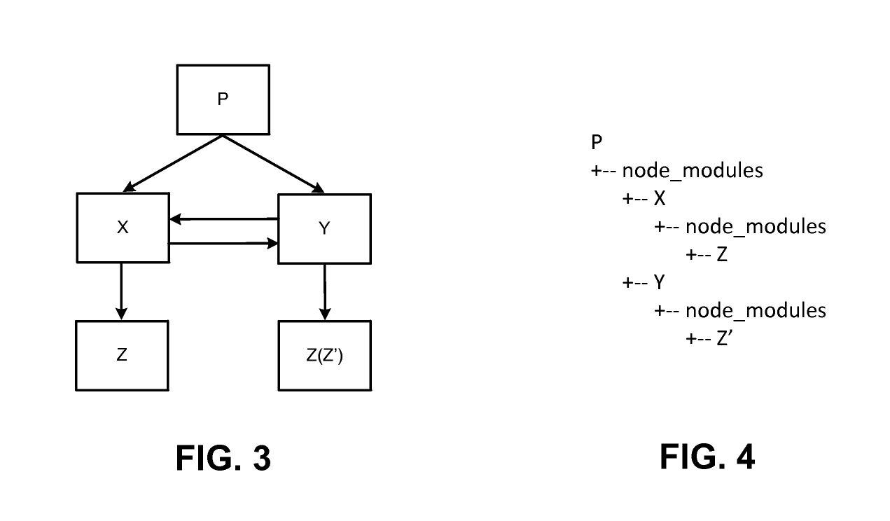

FIG. 3 shows an example of another software program application P containing cyclic dependencies. In the example of FIG. 3, the software program application P depends on software libraries X and Y. The software libraries X and Y depend on software library Z. Each of the software libraries X and Y can depend on a different version of software library Z. In addition, the software library X can depend on the software library Y and, vice versa, the software library Y can depend on the software library X.

FIG. 4 is a block diagram showing an example file system for organizing software modules of the example software program application P with a cyclic dependency as shown in FIG. 3. The two possibly different versions of the software library Z are placed in two different nested folders P/node_modules/X/node_modules and P/node_modules/Y/node_modules. The software library X also depends on the software library Y, so one can expect that folder P/node_modules/X/node_modules would also include a version of the software library Y. However, placing the software library Y in folder P/node_modules/X/node_modules would require placing a version of the software library X in folder P/node_modules/X/node_modules/Y/node/modules since the software library Y depends on the software library X, and so forth. This would require creating infinitely large folder trees. Therefore, a cyclic dependency is present, and the corresponding versions of the software libraries will not be placed in localized folders.

If the code from the software library X calls, for example, require(“Y”) instruction, then it will first check the local folder P/node_modules/X/node_modules for a version of software library Y. If the software library Y is not found in the local folder associated with the module X, the package manager will look for the software library Y in parent node_modules folder P/node_modules. Thus, the package manager first checks for the package in the local node_modules folder, then the parent's node_modules folder, and so on up the tree.

The following pseudocode illustrates an example of a lookup mechanism when Y's code executes require(X) instruction (a feature of a run-time system), for which the described technology is designed:

1. If X is a core module,

a. return the core module
b. STOP

2. If X begins with ‘./’ or ‘/’ or ‘../’

a. LOAD_AS_FILE(Y + X)
b. LOAD_AS_DIRECTORY(Y + X)

3. LOAD_NODE_MODULES(X, dirname(Y))
4. THROW “not found”
LOAD_AS_FILE(X)
1. If X is a file, load X as JavaScript text. STOP
2. If X.js is a file, load X.js as JavaScript text. STOP
3. If X.node is a file, load X.node as binary addon. STOP
LOAD_AS_DIRECTORY(X)
1. If X/package.json is a file,

a. Parse X/package.json, and look for “main” field.
b. let M = X + (json main field)
c. LOAD_AS_FILE(M)

2. If X/index.js is a file, load X/index.js as JavaScript text. STOP
3. If X/index.node is a file, load X/index.node as binary addon. STOP
LOAD_NODE_MODULES(X, START)
1. let DIRS=NODE_MODULES_PATHS(START)
2. for each DIR in DIRS:

a. LOAD_AS_FILE(DIR/X)
b. LOAD_AS_DIRECTORY(DIR/X)

NODE_MODULES_PATHS(START)
1. let PARTS = path split(START)
2. let ROOT = index of first instance of “node_modules” in PARTS, or 0
3. let I = count of PARTS − 1
4. let DIRS = [ ]
5. while I > ROOT,

a. if PARTS[I] = “node_modules” CONTINUE
c. DIR = path join(PARTS[0 .. I] + “node_modules”)
b. DIRS = DIRS + DIR
c. let I = I − 1

6. return DIRS

The following pseudocode illustrates an algorithm for installing a package in a folder, according to an embodiment of the described technology:

install(where, what, family, ancestors)
fetch what, unpack to <where>/node_modules/<what>
for each dep in what.dependencies

resolve dep to precise version

for each dep@version in what.dependencies

not in <where>/node_modules/<what>/node_modules/*
and not in <family>

```
  add precise version deps to <family>
  install(<where>/node_modules/<what>, dep, family)
```

For the package with structure A{B,C}, B{C}, C{D}, this algorithm produces:

A

+—B

′—C

′—D

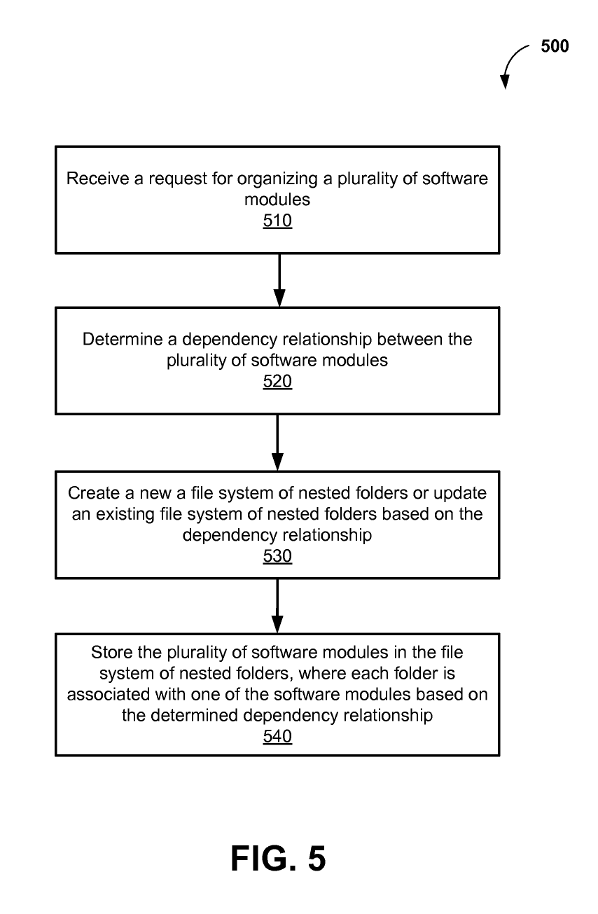

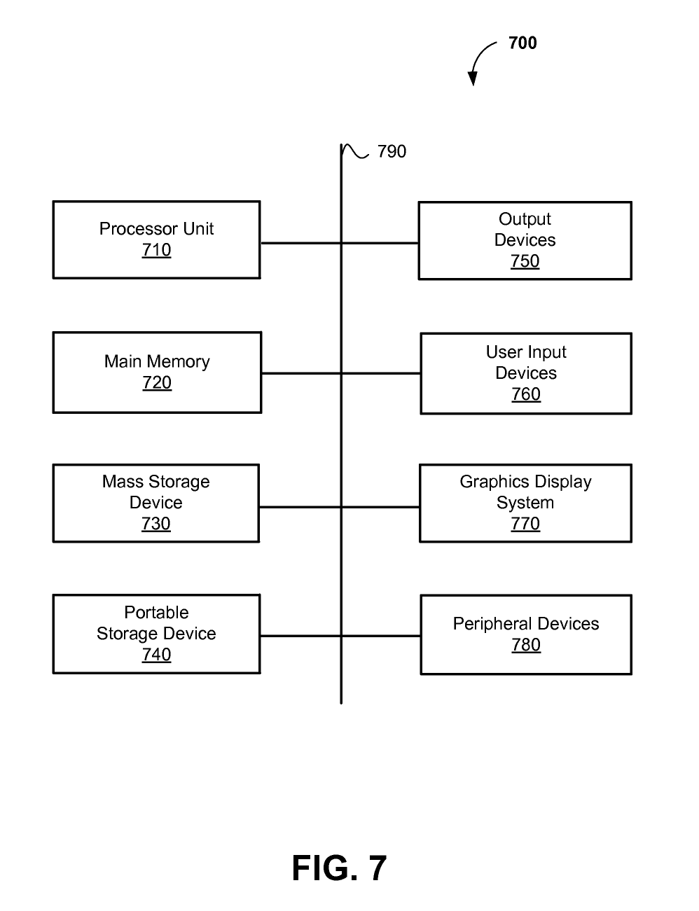

FIG. 5 is a process flow diagram showing an example method 500 for organizing a plurality of software modules, according to some embodiments of this disclosure. The method 500 may be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic refers to one or more computing system components shown in FIG. 7. Note that below recited steps of method 500 may be implemented in an order different than described and shown in FIG. 5. Moreover, the method 500 may have additional steps not shown herein, but which can be evident for those skilled in the art from the present disclosure. The method 500 may also have fewer steps than outlined below and shown in FIG. 5.

The method 500 commences at step 510 with receiving a request for organizing the plurality of software modules. The software modules can relate to a single software package, although in rare embodiments multiple software packages can be involved.

The request can be manually or automatically generated by a user or software package manager. In some embodiments, the request is generated upon run-time of the software package. In other embodiments, the request is generated upon designing or developing of the software package. In some embodiments, the step 510 can be optional or excluded from the method.

At step 520, the software package manager determines (i.e., assesses) a dependency relationship between the plurality of software modules. This step can involve determining which software modules depend on other dependent modules, their versions, their location, and so forth. For example, the software modules can include software libraries, where some of the software libraries can depend on other software modules, other software libraries, or other software program applications. In certain embodiments, at step 520, there can be determined a cyclic dependency or a conflicting dependency between two or more of the software modules.

At step 530, the software package manager creates a new a file system of nested folders or updates an existing file system of nested folders depending on the stage of development. The file system of nested folders is created or updated based on the determined dependency relationship between the plurality of software modules. It means that the file system includes a number of first level folders to be associated with the software modules, where the first level folders can have sub-folders (i.e., second level folders) to be associated with other software modules that the first software modules can depend upon. Similarly, the sub-folders can have their sub-folders, and so forth. The file system of nested folders includes as many trees as needed to separate all of the software modules and eliminate dependency conflicts.

At step 540, the software package manager stores the plurality of software modules in the file system of nested folders, where each folder is associated with one of the software modules based on the determined dependency relationship between the software modules. As described above, in example embodiments, the file system of nested folders can have a plurality of first level folders, each of which is associated with first software modules. At least one of the first software modules stored in the first level folders can depend on one or more second software modules, where the second software modules differ from the first software modules. In this case, the second software modules, which the at least one of the first software modules depends on, can be stored in corresponding second level folders, where the second level folders are sub-folders of the first level folders associated with the at least one of the first software modules.

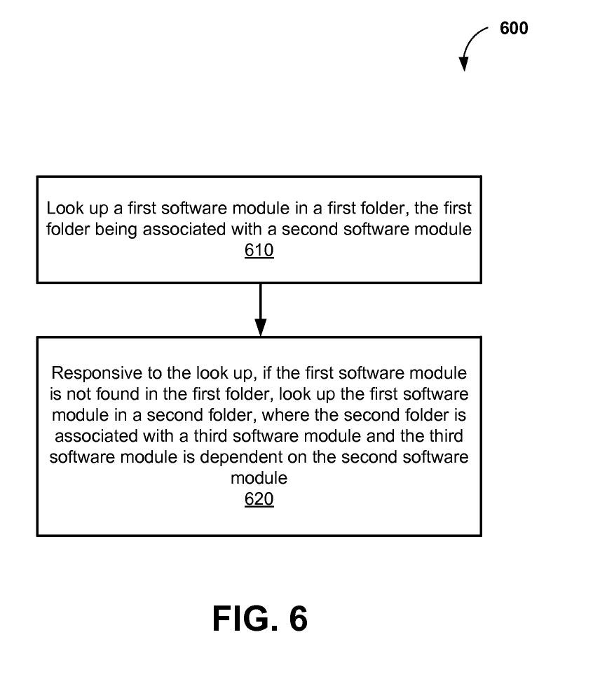

FIG. 6 is a process flow diagram showing an example method 600 for analyzing a dependency relationship between a plurality of software modules, according to some embodiments of this disclosure. Method 600 may be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic refers to one or more computing system components shown in FIG. 7. Note that below recited steps of method 600 may be implemented in an order different than described and shown in FIG. 6. Moreover, the method 600 may have additional steps not shown herein, but which can be evident for those skilled in the art from the present disclosure. The method 600 may also have fewer steps than outlined below and shown in FIG. 6. In yet more embodiments, method 600 is a continuation of the method 500 shown in FIG. 5.

The method 600 commences at step 610 with looking up a first software module in a first folder, which is associated with a second software module. The second software module can be dependent on the first software module.

At step 620, responsive to the looking up performed at step 610, if the first software module is not found in the first folder, looking up the first software module in a second folder, where the second folder is associated with a third software module and the third software module is dependent on the second software module. The step 620 can be repeatedly performed in a cycle until the first software module is located. Moreover, in certain embodiments, the step 620 can be performed with respect to more than two folders and can involve looking up in a third folder, fourth folder, fifth folder, and so forth. Also, the looking up can be performed with respect to any sub-folders.

The method 600 provides the approach for analyzing the dependency relationship and also locating a wanted software module. For this reason, the method 600 can be used independently from the method 500 to implement recalling features of a software package or similar functionality.

FIG. 7 illustrates an example computing system 700 that may be used to implement embodiments of the disclosed technology. In certain embodiments, the computing system 700 implements or relates to a software package manager, which can be used for implementing the methods 500 and 600 as discussed above.

The computing system 700 may be implemented in the contexts of the likes of computing systems, networks, servers, or combinations thereof. The computing system 700 includes at least one processor unit 710 and main memory 720. The main memory 720 stores, at least in part, instructions and data for execution by the processor unit 710. The main memory 720 may store the executable code when in operation. The computing system 700 of FIG. 7 further includes a mass storage device 730, portable storage device 740, output devices 750, user input devices 760, a graphics display system 770, and peripheral devices 780. Some or all of these items 730-780 are optional and not necessarily needed for proper operation of system 700.

The components shown in FIG. 7 are depicted as being connected via a single bus 790. The components may be connected through one or more data transport means. The processor unit 710 and main memory 720 may be connected via a local microprocessor bus, and the mass storage device 730, peripheral devices 780, portable storage device 740, and graphics display system 770 may be connected via one or more input/output (I/O) buses.

The mass storage device 730, which may be implemented with a magnetic disk drive, an optical disk drive, or a solid state drive, is a non-volatile storage device for storing data and instructions for use by the processor unit 710. The mass storage device 730 may store the system software for implementing embodiments of the present technology for purposes of loading that software into main memory 720.

The portable storage device 740 operates in conjunction with a portable non-volatile storage medium, such as a compact disk or Universal Serial Bus (USB) storage device, to input and output data and code to and from the computing system 700. The system software for implementing embodiments of the present technology may be stored on such a portable medium and input to the computing system 700 via the portable storage device 740.

The user input devices 760 provide a portion of a user interface. User input devices 760 may include one or more microphones, an alphanumeric keypad, such as a keyboard, for inputting alphanumeric and other information, or a pointing device, such as a mouse, a trackball, stylus, or cursor direction keys. The user input devices 760 may also include a touchscreen. Additionally, the computing system 700 includes optional output devices 750. Suitable output devices 750 include speakers, printers, network interfaces, and monitors.

The graphics display system 770 may include a liquid crystal display (LCD) or another suitable display device. The graphics display system 770 may receive textual and graphical information, and processes the information for output to the display device.

The peripheral devices 780 may include any computer support device to add additional functionality to the computing system 700. The peripheral devices 780 may include a communications modem, network interface, router, and the like.

The components provided in the computing system 700 of FIG. 7 are those typically found in computing systems that may be suitable for use with embodiments of the present technology and are intended to represent a broad category of such computer components that are well known in the art. Thus, the computing system 700 may be a server, personal computer, handheld computing system, telephone, mobile computing system, workstation, mainframe computer, wearable, or any other computing system. The computer may also include different bus configurations, networked platforms, multi-processor platforms, etc. Various operating systems may be used including Unix, Linux, Microsoft Windows, Mac OS, Palm OS, Android OS, or any other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a hard disk, magnetic storage medium, CD-ROM disk, digital video disk (DVD), Blu-ray Disc (BD), any other optical storage medium, RAM, PROM, EPROM, EEPROM, FLASH memory, and/or any other memory chip, module, or cartridge.

In some embodiments, the present technology may be implemented as a web server or in a cloud-based computing environment. A cloud-based computing environment is a resource that typically combines the computational power of a large grouping of processors and/or that combines the storage capacity of a large grouping of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

Thus, methods and systems for software package management have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for organizing a plurality of software modules, the method comprising:
receiving a request to organize the plurality of software modules;
determining a dependency relationship between the plurality of software modules;
creating or updating a file system of nested folders based on the dependency relationship between the plurality of software modules; and
storing the plurality of software modules in the file system of nested folders, wherein each folder is associated with one of the software modules based on the dependency relationship between the plurality of software modules.

2. The method of claim 1, wherein one or more of the software modules include a software library.

3. The method of claim 1, wherein the software modules are associated with and required to operate a single software application.

4. The method of claim 1, wherein the file system of nested folders includes a plurality of first level folders; and
wherein each of the first level folders is associated with first software modules.

5. The method of claim 4, wherein at least one of the first software modules stored in the first level folders depends on one or more second software modules; and
wherein the second software modules are different from the first software modules.

6. The method of claim 5, wherein the one or more second software modules on which the at least one of the first software modules depends are stored in the one or more second level folders, wherein the one or more second level folders are sub-folders of the one or more first level folders associated with the at least one of the first software modules.

7. The method of claim 1, wherein the storing of the plurality of software modules in the file system of nested folders includes placing the software modules in the folders in such a way that there is no cyclic dependency or conflicting dependency between two or more of the software modules at a run time of a software package which depends on the two or more software modules.

8. The method of claim 1, further comprising analyzing the dependency relationship between the plurality of software modules by:
looking up a first software module in a first folder, wherein the first folder is associated with a second software module, the second software module being dependent on the first software module; and
cyclically, responsive to the look up, if the first software module is not found in the first folder, looking up the first software module in a second folder, wherein the second folder is associated with a third software module and the third software module is dependent on the second software module.

9. The method of claim 1, wherein the plurality of software modules forms at least part of a software package.

10. The method of claim 1, wherein the determining of the dependency relationship between the plurality of software modules includes determining a cyclic dependency or a conflicting dependency between two or more of the software modules.

11. A software package manager, comprising:
a computing device including at least one processor and a memory storing processor-executable codes, which, when implemented by the at least one processor, cause the at least one processor to perform the steps of:
receiving a request for organizing a plurality of software modules;
determining a dependency relationship between the plurality of software modules;
creating or updating a file system of nested folders based on the dependency relationship between the plurality of software modules; and
storing the plurality of software modules in the file system of nested folders, wherein each folder is associated with one of the software modules based on the dependency relationship between the plurality of software modules.

12. The manager of claim 11, wherein one or more of the software modules include a software library.

13. The manager of claim 11, wherein the software modules are associated with and required to operate a single software application.

14. The manager of claim 11, wherein the file system of nested folders includes a plurality of first level folders, wherein each of the first level folders is associated with first software modules.

15. The manager of claim 14, wherein at least one of the first software modules stored in the first level folders depends on one or more second software modules, wherein the second software modules differ from the first software modules.

16. The manager of claim 15, wherein the one or more second software modules, which the at least one of the first software modules depends on, are stored in the one or more second level folders, wherein the one or more second level folders are sub-folders of the one or more first level folders associated with the at least one of the first software modules.

17. The manager of claim 11, wherein the storing of the plurality of software modules in the file system of nested folders includes placing the software modules in the folders in such a way that there are no cyclic dependencies and conflicting dependencies between two or more of the software modules.

18. The manager of claim 11, wherein the processor-executable codes, when implemented by the at least one processor, cause the at least one processor to perform analyzing of the dependency relationship between the plurality of software modules by:
looking up a first software module in a first folder, wherein the first folder is associated with a second software module, the second software module being dependent on the first software module; and
cyclically, responsive to the look up, if the first software module is not found in the first folder, looking up the first software module in a second folder, wherein the second folder is associated with a third software module and the third software module is dependent on the second software module.

19. The manager of claim 11, wherein the plurality of software modules forms at least part of a software package.

20. A non-transitory processor-readable medium having instructions stored thereon, which, when executed by one or more processors, cause the one or more processors to implement a method for organizing a plurality of software modules, the method comprising:
receiving a request for organizing a plurality of software modules;
determining a dependency relationship between the plurality of software modules;
creating or updating a file system of nested folders based on the dependency relationship between the plurality of software modules; and
storing the plurality of software modules in the file system of nested folders, wherein each folder is associated with one of the software modules based on the dependency relationship between the plurality of software modules.
